(19) United States
(12) Patent Application Publication
(10) Pub. No.: US 2021/0270494 A1
(43) Pub. Date: Sep. 2, 2021

(54) Electrically Heated Vessel

(71) Applicants: Andy Stahl, Camdenton, MO (US); Amy Robb, Camdenton, MO (US)

(72) Inventors: Andy Stahl, Camdenton, MO (US); Amy Robb, Camdenton, MO (US)

(21) Appl. No.: 16/802,716

(22) Filed: Feb. 27, 2020

(51) Int. Cl. F24H 9/18; F24H 9/20

(52) U.S. Cl. CPC F24H 9/1818; F24H 9/2021

(57) ABSTRACT

An electrically heated vessel having a heating element that is replaceable without draining the vessel includes a tank, which has an orifice positioned therein, and a housing. The housing is tubular and has a first terminus, which is closed, and a second terminus, which is open. The second terminus is coupled to the tank with the housing extending from the orifice into the tank. The housing has a plurality of first apertures positioned therein. A tube, which has a plurality of second apertures positioned therein, is positioned in and rotationally engaged to the housing. The tube has a first end, which is closed, and a second end, which is open and selectively couplable to an electric heating element that is inserted thereinto. Each second aperture is selectively alignable with an associated first aperture so that the electric heating element can heat a fluid positioned in the tank.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to heated vessels and more particularly pertains to a new heated vessel having a heating element that is replaceable without draining the vessel.

### (2) Description of Related Art Including Information Disclosed Under 37 CFR 1.97 and 1.98

The prior art relates to heated vessels and does not provide for the base features of the invention.

### BRIEF SUMMARY OF THE INVENTION

An embodiment of the disclosure meets the needs presented above by generally comprising a tank, a housing, and a tube. The tank defines an interior space and has an orifice positioned therein. The tank may comprise a water heater, or other type of heating vessel, such as, but not limited to, holding tanks, aquariums, swimming pools, fermentation tanks, and the like.

The housing is tubular and has a first terminus, which is closed, and a second terminus, which is open. The second terminus is coupled to the tank so that the housing extends from the orifice into the interior space. The housing has a plurality of first apertures positioned therein.

The tube, which has a plurality of second apertures positioned therein, is positioned in and is rotationally engaged to the housing. The tube has a first end, which is closed, and a second end, which is open and configured to be selectively couplable to an electric heating element that is inserted thereinto. Each second aperture selectively alignable with an associated first aperture, upon rotation of the tube relative to the housing, so that the electric heating element is configured to heat a fluid, such as water, that is positioned in the interior space. The electric heating element thus can be changed without draining the fluid from the electrically heated vessel.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an electrically heated vessel according to an embodiment of the disclosure.

FIG. 2 is a front view of an embodiment of the disclosure.

FIG. 3 is a detail view of an embodiment of the disclosure.

FIG. 4 is an exploded view of an embodiment of the disclosure.

FIG. 5 is a detail view of an embodiment of the disclosure.

FIG. 6 is a detail view of an embodiment of the disclosure.

FIG. 7 is an in-use view of an embodiment of the disclosure.

FIG. 8 is an in-use view of an embodiment of the disclosure.

### DETAILED DESCRIPTION OF THE INVENTION

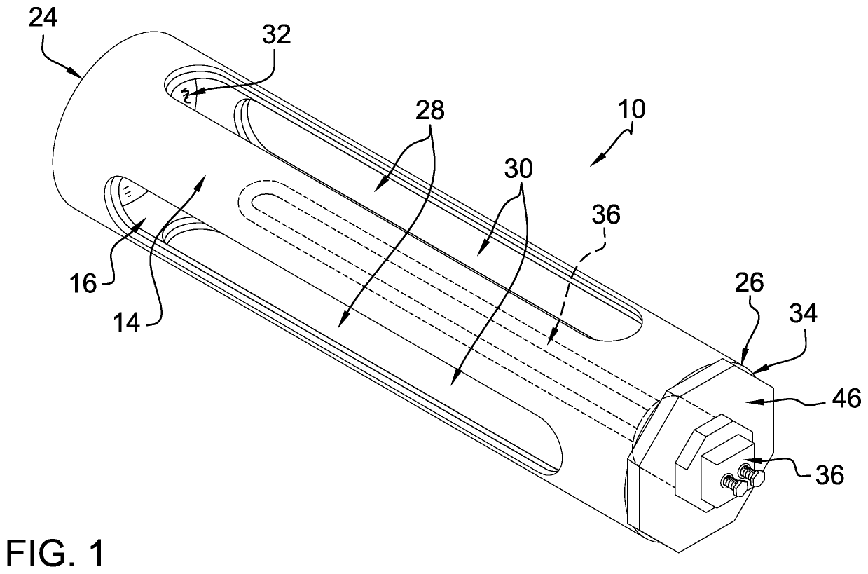

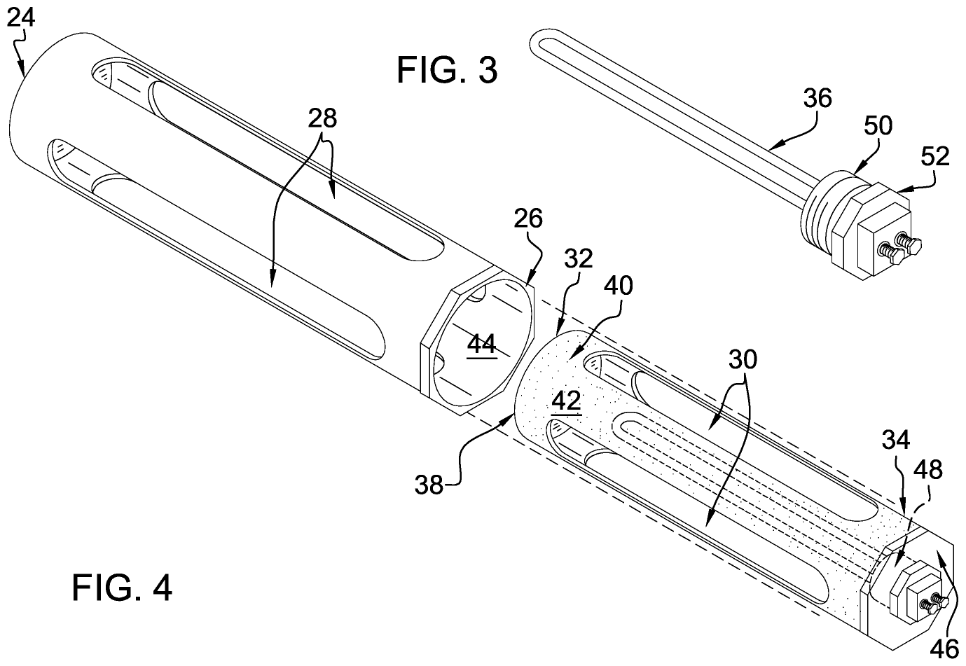

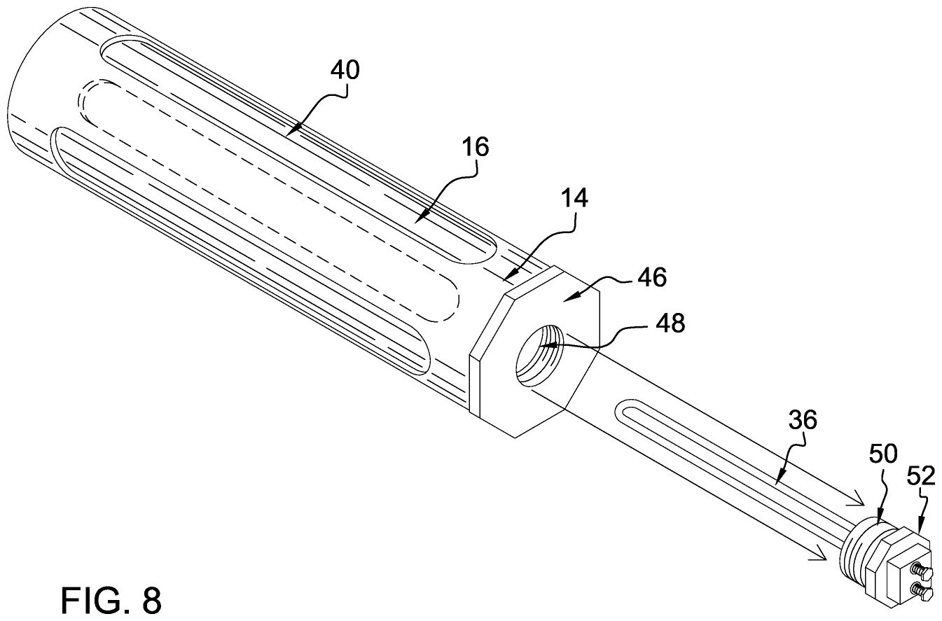

With reference now to the drawings, and in particular to FIGS. 1 through 8 thereof, a new heated vessel embodying the principles and concepts of an embodiment of the disclosure and generally designated by the reference numeral 10 will be described.

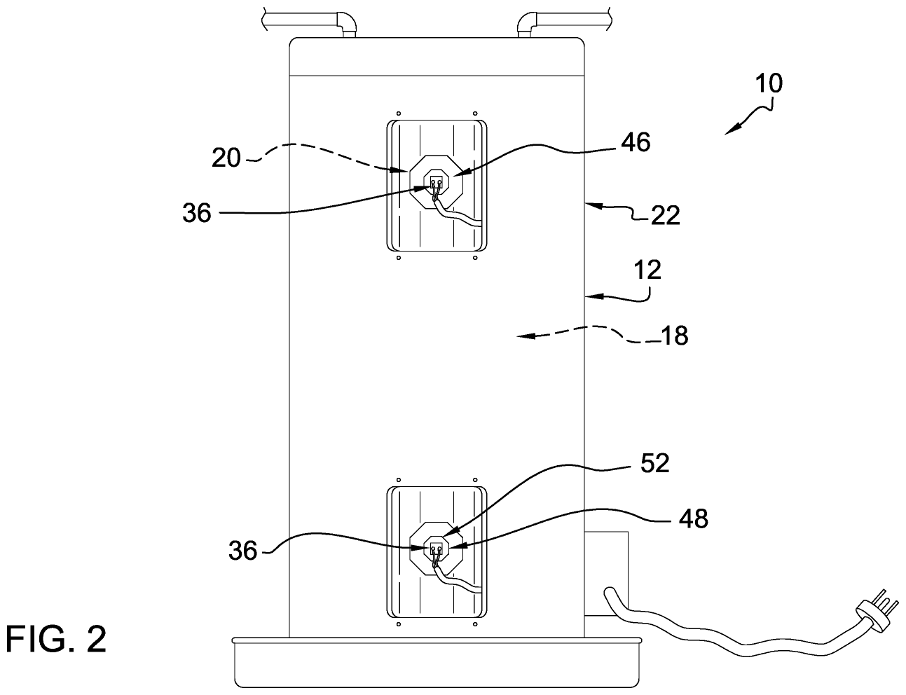

As best illustrated in FIGS. 1 through 8, the electrically heated vessel 10 generally comprises a tank 12, a housing 14, and a tube 16. The tank 12 defines an interior space 18 and has an orifice 20 positioned therein. The tank 12 may comprise a water heater 22, as shown in FIG. 2, or other type of heating vessel, such as, but not limited to, holding tanks, aquariums, swimming pools, fermentation tanks, and the like.

The housing 14 is tubular and has a first terminus 24, which is closed, and a second terminus 26, which is open. The second terminus 26 is coupled to the tank 12 so that the housing 14 extends from the orifice 20 into the interior space 18. The housing 14 has a plurality of first apertures 28 positioned therein.

The tube 16, which has a plurality of second apertures 30 positioned therein, is positioned in and is rotationally engaged to the housing 14. The tube 16 has a first end 32, which is closed, and a second end 34, which is open and configured to be selectively couplable to an electric heating element 36 that is inserted thereinto. Each second aperture 30 is selectively alignable with an associated first aperture 28, upon rotation of the tube 16 relative to the housing 14, so that the electric heating element 36 is configured to heat a fluid, such as water, that is positioned in the interior space 18. The electric heating element 36 thus can be changed without draining the fluid from the electrically heated vessel 10.

Each first aperture 28 may extend from proximate to the first terminus 24 to proximate to the second terminus 26, as shown in FIG. 4. As will become apparent, the first apertures 28 may be shaped and positioned in a variety of ways. The only limitation is that the tube 16 must close all the first apertures 28 at some point in its rotation relative to the housing 14.

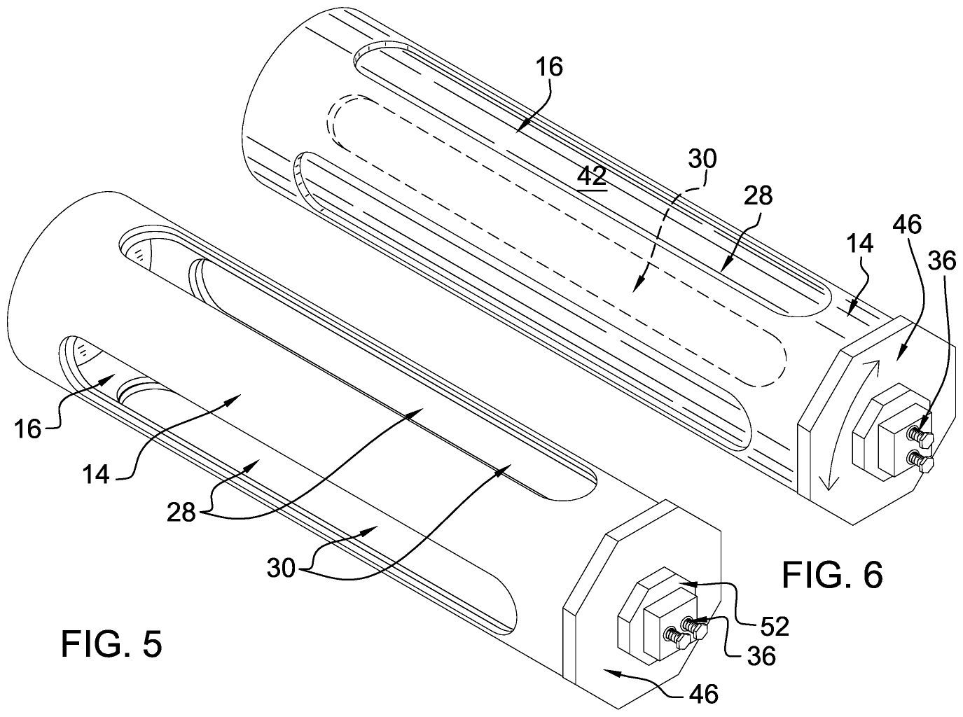

The plurality of second apertures 30 may comprise four second apertures 30 that are evenly spaced around a circumference 38 of the tube 16, as shown in FIG. 4. The tube 16 is configured to be rotated 90 degrees relative to the housing 14 from a closed configuration, as shown in FIG. 6, to an open configuration, as shown in FIG. 5. In the closed configuration, the second aperture 30 is not aligned with the associated first aperture 28 and the electric heating element 36 is removable from the tube 16, with only the fluid in the tube 16 draining from the tank 12. In the open configuration, the second aperture 30 is aligned with the associated first aperture 28 and the electric heating element 36 is configured to heat the fluid that is positioned in the interior space 18.

A coating 40 is positioned on an exterior face 42 of the tube 16. The coating 40 is resiliently compressible so that the coating 40 is positioned to sealably engage an interior surface 44 of the housing 14 when the tube 16 is in the closed configuration. The coating 40 thus is configured to prevent the fluid is the interior space 18 from entering the tube 16. The coating 40 comprises at least one of elastomer, rubber, and silicone.

A plate 46 is coupled to the second end 34 of the tube 16 and is positioned externally to the tank 12. The plate 46 has an opening 48 positioned therein. The opening 48 is internally threaded and is configured to threadedly insert a threaded section 50 of the electric heating element 36 to couple the electric heating element 36 to the plate 46. The plate 46 is polygonally shaped and thus is configured to engage a first wrench (not shown), positioning a user to apply torque to the plate 46 to rotate the tube 16 relative to the housing 14. The plate 46 is at least one of squarely shaped, hexagonally shaped, and octagonally shaped, and thus readily engageable by the first wrench.

The electric heating element 36 has a nut 52 coupled thereto. The nut 52 is configured to engage a second wrench (not shown). The user is positioned to apply torque to the nut 52 to rotate the electric heating element 36 relative to the plate 46, while maintaining the plate 46 stationary relative to the housing 14 using the first wrench.

The present invention anticipates the second end 34 of the tube 16 being configured for coupling to electric heating elements that are couplable by other means, such as, but not limited to, triclamps, bolts, and the like.

The present invention also anticipates the housing 14 being selectively couplable to a prior art water heater. In a first example, the housing 14 could be externally threaded proximate to the second terminus 26, allowing it to be threadedly coupled to an element opening of the prior art water heater. In a second example, a bulkhead fitting (not shown) complementary to the housing 14 could be installed in a sidewall of the prior art water heater, and the housing 14 positioned thereinto.

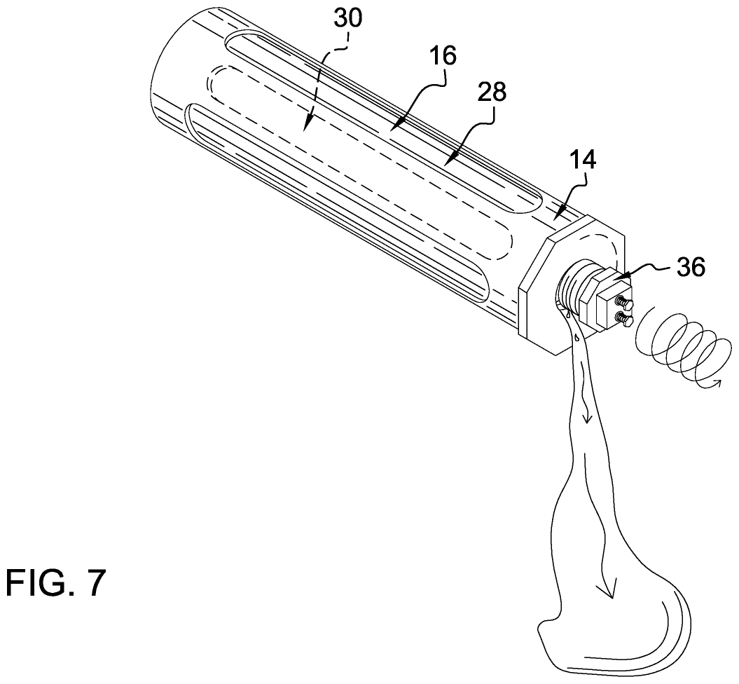

In use, the electrically heated vessel 10, such as the water heater 22, is installed and utilized as per prior art vessels. When the electric heating element 36 requires replacement, the user engages the plate 46 with the first wrench and rotates the tube 16 from the open configuration, as shown in FIG. 5, to the closed configuration, as shown in FIG. 6. The second wrench then is applied to the nut 52 to loosen the electric heating element 36, as shown in FIG. 7. A small amount of water will drain from the tube 16, however, draining of the water heater 22 is not required as with per prior art vessels. The replacement electric heating element 36 then is threaded into the opening 48 to sealably couple it to the plate 46. The first wrench then is used to rotate the plate 46 and the tube 16 to the open configuration, followed by final tightening of the nut 52 with the second wrench.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. An electrically heated vessel comprising:
a tank defining an interior space, the tank having an orifice positioned therein;
a housing, the housing being tubular and having a first terminus and a second terminus, the first terminus being closed, the second terminus being open and coupled to the tank such that the housing extends from the orifice into the interior space, the housing having a plurality of first apertures positioned therein; and
a tube positioned in and rotationally engaged to the housing, the tube having a first end and a second end, the first end being closed, the second end being open, the tube being configured to be selectively couplable to an electric heating element inserted thereinto, the tube having a plurality of second apertures positioned therein, each second aperture being selectively alignable with an associated first aperture upon rotation of the tube relative to the housing, wherein the electric heating element is configured for heating a fluid positioned in the interior space.

2. The electrically heated vessel of claim 1, wherein the tank comprises a water heater.

3. The electrically heated vessel of claim 1, wherein each first aperture extends from proximate to the first terminus to proximate to the second terminus.

4. The electrically heated vessel of claim 3, wherein:
the plurality of second apertures comprises four second apertures evenly spaced around a circumference of the tube; and
the tube is configured for rotating 90 degrees relative to the housing from a closed configuration, wherein the second aperture is not aligned with the associated first aperture, and in which the electric heating element is removable, to an open configuration, wherein the second aperture is aligned with the associated first aperture, and wherein the electric heating element is configured for heating the fluid positioned in the interior space.

5. The electrically heated vessel of claim 4, further including a coating positioned on an exterior face of the tube, the coating being resiliently compressible such that the coating is positioned for sealably engaging an interior surface of the housing when the tube is in the closed configuration, wherein the coating is configured for preventing the fluid is the interior space from entering the tube.

6. The electrically heated vessel of claim 5, wherein the coating comprises at least one of elastomer, rubber, and silicone.

7. The electrically heated vessel of claim 1, further including a plate coupled to the second end of the tube and positioned externally to the tank, the plate having an opening positioned therein, the opening being internally threaded such that the opening is configured for threadedly inserting a threaded section of the electric heating element for coupling the electric heating element to the plate.

8. The electrically heated vessel of claim 7, wherein the plate is polygonally shaped, wherein the plate is configured for engaging a first wrench, positioning a user for applying torque to the plate for rotating the tube relative to the housing.

9. The electrically heated vessel of claim 8, wherein the plate is at least one of squarely shaped, hexagonally shaped, and octagonally shaped.

10. The electrically heated vessel of claim 8, wherein the electric heating element has a nut coupled thereto, wherein the nut is configured for engaging a second wrench positioning the user for applying torque to the nut, for rotating the electric heating element relative to the plate while maintaining the plate stationary relative to the housing using the first wrench.

11. An electrically heated vessel comprising:
a tank defining an interior space, the tank having an orifice positioned therein, the tank comprising a water heater;
a housing, the housing being tubular and having a first terminus and a second terminus, the first terminus being closed, the second terminus being open and coupled to the tank such that the housing extends from the orifice into the interior space, the housing having a plurality of first apertures positioned therein, each first aperture extending from proximate to the first terminus to proximate to the second terminus;
a tube positioned in and rotationally engaged to the housing, the tube having a first end and a second end, the first end being closed, the second end being open, the tube being configured to be selectively couplable to an electric heating element inserted thereinto, the tube having a plurality of second apertures positioned therein, each second aperture being selectively alignable with an associated first aperture upon rotation of the tube relative to the housing, wherein the electric heating element is configured for heating a fluid positioned in the interior space, the plurality of second apertures comprising four second apertures evenly spaced around a circumference of the tube, the tube being configured for rotating 90 degrees relative to the housing from a closed configuration, wherein the second aperture is not aligned with the associated first aperture, and in which the electric heating element is removable, to an open configuration, wherein the second aperture is aligned with the associated first aperture, and wherein the electric heating element is configured for heating the fluid positioned in the interior space;
a coating positioned on an exterior face of the tube, the coating being resiliently compressible such that the coating is positioned for sealably engaging an interior surface of the housing when the tube is in the closed configuration, wherein the coating is configured for preventing the fluid is the interior space from entering the tube, the coating comprising at least one of elastomer, rubber, and silicone; and
a plate coupled to the second end of the tube and positioned externally to the tank, the plate having an opening positioned therein, the opening being internally threaded such that the opening is configured for threadedly inserting a threaded section of the electric heating element for coupling the electric heating element to the plate, the plate being polygonally shaped, wherein the plate is configured for engaging a first wrench positioning a user for applying torque to the plate for rotating the tube relative to the housing, the plate being at least one of squarely shaped, hexagonally shaped, and octagonally shaped, the electric heating element having a nut coupled thereto, wherein the nut is configured for engaging a second wrench positioning the user for applying torque to the nut, for rotating the electric heating element relative to the plate while maintaining the plate stationary relative to the housing using the first wrench.
